(19) United States
(12) Patent Application Publication
(10) Pub. No.: US 2005/0223247 A1
(43) Pub. Date: Oct. 6, 2005

(54) Portable computer with various operational states

(75) Inventor: Thorsten Hohnke, Konigsbrunn (DE)

Correspondence Address: COHEN, PONTANI, LIEBERMAN & PAVANE, 551 Fifth Avenue, Suite 1210, New York, NY, 10176, US

(73) Assignee: Fujitsu Siemens Computers GmbH, Munchen (DE)

(21) Appl. No.: 11/085,024

(22) Filed: Mar. 16, 2005

(30) Foreign Application Priority Data
Mar. 16, 2004 (DE) 10 2004 012 854.5

(51) Int. Cl. G06F 1/26

(52) U.S. Cl. 713/300

(57) ABSTRACT

A portable computer, such as a pocket PC having a device (3) for wireless data transmission, includes a control device (7) for setting various operational states. An operating system is provided in which the device (3) for wireless data transmission is in a state of full functionality (A) while further components can be in a sleep mode (S) with limited functionality and reduced power consumption. At each switchover to this operational state, the control device (7) determines, according to specified criteria, which components are to be placed into sleep mode (S).

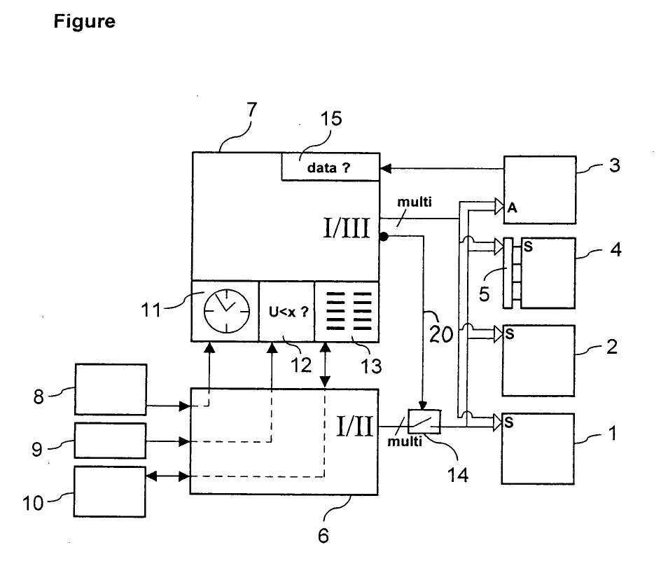

### RELATED APPLICATIONS

This patent application claims the priority of German patent application 102004 012 854.5 filed Mar. 16, 2004, the disclosure content of which is hereby incorporated by reference.

### FIELD OF THE INVENTION

The invention relates to a portable computer arrangement and to a method for setting various operational states for such a portable computer in order to reduce power consumption and thereby conserve battery power.

### BACKGROUND OF THE INVENTION

The term “pocket PC” refers to portable computers which can easily be held in one hand. Alternatively they are also referred to as handhelds or organisers. Mobile telephones with functions that go beyond phoning and sending SMS (Short Messenger Service) messages and which are often referred to as smart phones also belong to this group. They all share the common feature of being significantly smaller than other portable computers such as for example laptops or notebooks. Application programs from the fields of address and appointments administration, word processing or data presentation—albeit with slightly reduced capabilities—are frequently also available for pocket PCs.

Many pocket PCs comprise devices for wireless data transmission, which devices are either built-in or optionally available as plug-in cards for insertion into plug-in slots. The term “data transmission” refers to the exchange of information, possibly also bi-directional information. In this context, the term “data transmission” not only refers to the transmission of data or data packets in a data network but also to the transmission of voice, images and news, e.g. SMS or e-mail, in a communication network. Concrete examples in these areas include devices for data transmission in local networks, for example WLAN (Wireless Local Area Network) or BT (Bluetooth), and in global communication networks such as GSM (Global System of Mobile Communication), GPRS (Global Packaging Radio System) or UMTS (Universal Mobile Telecommunication System) as well as receiving devices for radio services, such as for example for GPS (Global Positioning System).

Due to their more extensive range of functions, above all due to their improved computing power and the larger display, the operational duration with one battery charge is usually considerably shorter in pocket PCs when compared for example to that of pure mobile telephones. In particular in the operation of devices for wireless data transmission, this problem is exacerbated if availability in the wireless network is to be ensured for an extended period of time. Normally the operating systems of commercially available pocket PCs only provide two operational states of varying power consumption and thus varying operational duration in battery operation.

In a first operational state essentially all the components of the portable computer are in a state of full functionality. The only exception to this in commercially available pocket PCs is the display. If during an extended period of time there is no input from the user, background lighting of the display is turned off so as to save power. For the same reason, in battery mode the contrast of the display is lower than in mains mode.

In a second operational state, essentially all the components of the portable computer are in sleep mode, which is a state of limited functionality and reduced power consumption. In this state, as a rule, only the internal clock continues to operate, and any operation of the input keys is monitored, with such operation then resulting in the first operational state being restored. Furthermore, there can be an additional state in which the entire device, again with the exception of an internal clock, is switched to be without current, and can only be switched on by way of a switch, rather than by pressing a key as is the case in the second operational state.

These operational states are unsuitable for permanent operation with devices for wireless data transmission or communication. In the first operational state the power consumption is too high and consequently the duration of operation in battery mode is too short. In the second operational state the availability in the wireless network is not ensured. Similarly, any further non-interactive functions that may be desired, e.g. playing music, are not available in the second operational state.

### SUMMARY OF THE INVENTION

One object of the invention is to provide a portable computer in which the various operational states are set in such a manner that the power consumption is reduced while, at the same time, every desired functionality of the portable computer remains available.

This and other objects are attained in accordance with one aspect of the present invention directed to a technique applicable to a portable computer, including a particular device as a component of the portable computer. A first operational state can be set in which essentially all the components of the portable computer are in a state of full functionality. A second operational state can be set in which essentially all the components of the portable computer are in sleep mode, which is a state of limited functionality and reduced power consumption, or are off. A third operational state can be set in which the particular device is in the state of full functionality, and a determination is made, upon switchover from the first operational state to the third operational state, whether other components of the portable computer are needed by any application program, from among a predetermined group of application programs, that is then being executed on the portable computer. Then, only unneeded ones of the other components are set in the sleep mode with limited functionality and reduced power consumption, or off.

Another aspect of the present invention is directed to a technique applicable to a portable computer, including a particular device as a component of the portable computer. A first operational state can be set in which essentially all the components of the portable computer are in a state of full functionality. A second operational state can be set in which essentially all the components of the portable computer are in sleep mode, which is a state of limited functionality and reduced power consumption, or are off. A third operational state can be set in which the particular device is in the state of full functionality, and upon switchover from the first operational state to the third operational state, all application programs then being executed on the portable computer are interrupted, provided that such application programs are not among a predetermined group of application programs (10).

The invention is based on ensuring availability by way of the device for, for example, wireless data transmission even during those times when the functionality of some other components of the computer is limited. As a result of this the power consumption of the portable computer is reduced, and the duration of operation in battery mode increases. For this purpose a control device is described which controls switchover to the third operational state and during each switchover determines which components of the portable computer may be placed in sleep mode with reduced power consumption, without limiting the function of the device for wireless data transmission and without hindering the execution of desired user applications.

In this arrangement the control device can switch the portable computer back to the first operational state if required, if the at least one device for wireless data transmission signals the arrival of incoming data.

### BRIEF DESCRIPTION OF THE SINGLE DRAWING

The FIGURE shows a diagrammatic representation of a portable computer with a control device for setting various operational states.

### DETAILED DESCRIPTION OF THE SINGLE DRAWING

By way of example, the FIGURE shows the following components of a portable computer: a display terminal 1, a processor 2, a device for wireless data transmission 3, and a plug-in card 4 for insertion into a plug-in slot 5. These components are connected to an operating system 6 and to a control device 7. The operating system 6 receives information from operating devices 8, a battery 9, as well as one or several application programs 10, and forwards said information to the control device 7. The control device 7 comprises a timekeeper 11, a monitoring device 12 as well as a table comprising application programs 13. Furthermore, there is a means 14 with which switchover to the second operational state II can be blocked, and a data input detection means 15 which signals the input of data at the device 3 for wireless data transmission, of which device 3 there is at least one.

The FIGURE is not intended to show a complete block diagram for a portable computer, but instead it shows the components which are necessary, according to the invention, for setting various operational states for a portable computer.

Each of the components 1 to 4 of a portable computer, which components are shown in the FIGURE, comprises control means for switching over from an active state with full functionality A to sleep mode S, which is a state of limited functionality and reduced power consumption. The sleep mode S can be implemented in a different manner in relation to the various components. In relation to the display terminal 1 it is for example possible to save power by turning off the display or the back-lighting. As an alternative, in addition to the above, the graphic unit which handles processing of the display contents can be switched off. In relation to the processor 2 there is the option of reducing not only the operating frequency but also the operating voltage, as a result of which the power consumption of the processor is reduced, although the processor is less capable. There is also the option of stopping the processor altogether and of providing processing of commands to be started again by way of a so-called interrupt signal. Other components, such as for example the plug-in card 4, which has been inserted into plug-in slot 5, can be completely switched off in sleep mode, provided their functionality is not needed at the time.

In the initial situation the portable computer is in the first operational state I. The timekeeper 11 in the control device 7 determines the length of the time span during which none of the operating devices 8 is operated. The information necessary for this is provided by the operating system 6. If this period of time exceeds a predefined period of time, which may be modified by the user, the control device 7 initiates a switchover to the third operational state III.

In this third operational state III, various components of the computer are switched to sleep mode S with reduced power consumption. At each switchover from the first operation state I to the third operational state III the control device 7 determines, according to specified criteria, which components are to be placed into state S. It must be ensured that any devices for wireless data transmission, which devices at the time of switchover have an active wireless connection, i.e. are for example logged on to a wireless network, continue to remain in state A. Furthermore, the control device 7, by way of the operating system 6, determines information as to which application programs 10 are being executed on the portable computer at the time of switchover. The name of these application programs 10 is compared to the entries in table 13. Table 13 lists those application programs 10 which during switchover to the third operational state III are to continue being executed. If the name of an application program 10 is not listed in table 13, the control device 7 instructs the operating system 6 to stop the application program 10 because each application program 10 executed in the third operational state III leads to increased power consumption as a result of memory access and processor usage. If the name of an application program 10 is listed in table 13, said application program 10 is not stopped. Table 13 also lists the components of the portable computer that are absolutely necessary to execute the application program 10. During switchover to the third operational state III, these components of the portable computer are not set to sleep mode S. Such an application program 10 could for example be a program for playing music files. To prevent interruption to the playing of music during switchover to the third operational state III, for example an audio output unit must not enter sleep mode S, while in contrast to the above, processor 2 can be made to enter sleep mode S because there is no need for its full functionality.

During the third operational state III the control device 7 by way of the detection means 15 monitors whether one of the devices 3 for wireless data transmission is signaling incoming data. Such transmission and signaling of data is described in the bus-protocol specification, and operational details of detection means 15 are well known to anyone with ordinary skill in the art. In this arrangement, incoming data not only relates to data in a data network, such as incoming calls, but also to SMS (Short Messenger Service) data in a communication network. The control device 7 then switches back to the first operational state I, which ensures that incoming data can be adequately processed.

Switchover from first operational state I to second operational state II has been described above in connection with the prior art. Operating system 6 also effects such a switchover automatically (auto power-off) if the device is unused for a predetermined period of time.

In the first and third operational states I and III, the control device 7, by way of means 14, prevents any switchover to the second operational state II, which switchover may have been instructed by the operating system 6. This prevents a situation where, as a result of an instruction by the operating system, an operational state is instructed in which the availability within wireless networks is not ensured. Means 14 is preferably an electronically controlled switch receiving a control signal over control line 20 from control device 7. The word “multi” on the drawing indicates the presence of more than one signal line.

However, if the voltage of the usually rechargeable battery 9 drops below a critical value, functioning of the device 3 for wireless data communication can in principle no longer be maintained. In such a case it is more important for the remaining charge of the battery 9 to be used for bringing the portable computer in a controlled way into the second operational state II with the lowest power consumption.

Switching to the second operational state II is a complex procedure since in this process essentially all the components of the portable computer are brought to sleep mode S, and data integraty has to be ensured in that the data content of volatile memory media remains intact. For this purpose the monitoring device 12 checks the voltage of the battery 9. Sufficient battery charge must remain to effect switchover to second operational state II without any loss of data (e.g., saving all data from volatile memory to non-volatile memory). If the control device 7 were handling the task of setting the operational states, then it would need to itself handle this complex procedure. However, instead of doing this the following procedure is implemented. If the voltage drops below a specified value, the control device 7 deactivates the means 14 for suppressing the second operational state II and thus makes it possible for the operating system 6 to effect switchover to the second operational state II. Returning full control over the components of the computer to the operating system 6 during this switchover advantageously frees the control device 7 from having to include expensive means to maintain data integrity.

In a further embodiment, switching among the operational states I to III can in addition be instructed manually by the user.

Thus, according to an embodiment of the invention, among several operational states is an operational state in which only certain components of the portable computer are set to sleep mode S with limited functionality and reduced power consumption. In this method the allocation is dynamic in that during every changeover to this operational state, by means of specified criteria it is determined anew which components may be placed into sleep mode S.

This method is advantageously applied to portable computers which include devices for wireless data transmission. However the method is not limited to these.

The scope of protection of the invention is not limited to the examples given hereinabove. The invention is embodied in each novel characteristic and each combination of characteristics, which includes every combination of any features which are stated in the claims, even if this combination of features is not explicitly stated in the claims.

1. A portable computer, including a particular device (3) as a component of the portable computer, comprising:
means for setting a first operational state (I) in which essentially all the components of the portable computer are in a state of full functionality (A);
means for setting a second operational state (II) in which essentially all the components of the portable computer are in sleep mode (S), which is a state of limited functionality and reduced power consumption, or are off; and
means for setting a third operational state (III), in which the particular device (3) is in said state of full functionality (A), and including means for determining, upon switchover from said first operational state (I) to said third operational state (III), whether other components of the portable computer are needed by any application program, from among a predetermined group of application programs (10), that is then being executed on the portable computer, and for setting only unneeded other components in sleep mode (S) with limited functionality and reduced power consumption, or off.

2. The portable computer according to claim 1,
wherein
said determining means includes means for storing a table (13) in which all said predetermined group of application programs are listed.

3. The portable computer according to claim 2,
wherein
said means for setting a third operational state includes a control device (7) that, during said changeover to the third operational state (III), interrupts all the application programs (10) being executed at the time of the changeover, provided such application programs (10) are not listed in the table (13).

4. The portable computer according to claim 1,
wherein
said means for setting a third operational state includes a timekeeper (11) which, during the first operational state (I), determines a time span in which no input to the portable computer occurs, and sets the third operational state (III) if the time span exceeds a specified value.

5. The portable computer according to claim 1,
wherein the particular device is for wireless data transmission, and the portable computer further comprises a detection means (15) which, during the third operational state (III), monitors whether incoming data arrives on the particular device (3) for wireless data transmission, and
wherein the means for setting the first operational state (I) sets the first operational state (I) if there is incoming data.

6. The portable computer according to claim 1,
further comprising means (14) for preventing any switchover to the second operational state (II), which switchover may be actuated by operating system (6) of the portable computer.

7. The portable computer according to claim 6,
further comprising a battery (9) and a monitoring means (12) for monitoring a charge state of the battery (9); and
wherein said switchover preventing means does not prevent any switchover to the second operational state (II) that may be actuated by operating system (6) in those cases where the charge state of the battery (9) drops below a specified value.

8. The portable computer according to claim 1,
further comprising operating devices (8) for effecting manual switchover among the various operational states (I, II or III).

9. The portable computer according to claim 1,
further comprising at least one plug-in space (5) for plug-in cards (4) for expanding the functionality of the portable computer.

10. The portable computer according to claim 9,
wherein the particular device (3) is a plug-in card (4) for wireless data transmission.

11. The portable computer according to claim 1,
wherein the particular device (3) is for wireless data transmission corresponding to a WLAN (Wireless Local Area Network), a BT (Bluetooth), a GPRS (Global Packaging Radio System), a GSM (Global System for Mobile Communication), a UMTS (Universal Mobile Telecommunication System) or a GPS (Global Positioning System) standard.

12. A method for setting various operational states for a portable computer, including a particular device (3) as a component of the portable computer, comprising:
setting a first operational state (I) in which essentially all the components of the portable computer are in a state of full functionality (A);
setting a second operational state (II) in which essentially all the components of the portable computer are in sleep mode (S), which is a state of limited functionality and reduced power consumption, or are off; and
setting a third operational state (III), in which the particular device (3) is in said state of full functionality (A), and including determining, upon switchover from said first operational state (I) to said third operational state (III), whether other components of the portable computer are needed by any application program, from among a predetermined group of application programs (10), that is then being executed on the portable computer, and for setting only unneeded other components in the sleep mode (S) with limited functionality and reduced power consumption, or off.

13. The method according to claim 12,
wherein said step of setting a third operational state (III) includes switchover from the first operational state (I) to the third operational state (III) if during a period of time which exceeds a specified period no input on the portable computer is made; and
wherein the particular device (3) is for wireless data transmission, and effecting switchover from the third operational state (III) to the first operational state (I) if data is received by the particular device (3) for wireless data transmission.

14. The method according to claim 12, wherein switchover of the operational state under instructions by the operating system (6) is prevented.

15. A portable computer, including a particular device (3) as a component of the portable computer, comprising:
means for setting a first operational state (I) in which essentially all the components of the portable computer are in a state of full functionality (A);
means for setting a second operational state (II) in which essentially all the components of the portable computer are in sleep mode (S), which is a state of limited functionality and reduced power consumption, or are off; and
means for setting a third operational state (III), in which the particular device (3) is in said state of full functionality (A), and including means for interrupting, upon switchover from said first operational state (I) to said third operational state (III), all application programs then being executed on the portable computer, provided that such application programs are not among a predetermined group of application programs (10).
